(19) United States
(12) Patent Application Publication
(10) Pub. No.: US 2006/0195963 A1
(43) Pub. Date: Sep. 7, 2006

(54) PROTECTIVE METHOD USING REVERSIBLE GARMENT FOR MILITARY OR PARAMILITARY FIREFIGHTER

(76) Inventors: William L. Grilliot, Dayton, OH (US); Mary I. Grilliot, Dayton, OH (US); Patricia Lewis, Huber Heights, OH (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/782,273

(22) Filed: Feb. 19, 2004

Related U.S. Application Data
(63) Continuation of application No. 10/350,862, filed on Jan. 24, 2003, now abandoned.

(51) Int. Cl. A62B 17/00

(52) U.S. Cl. 2/81

(57) ABSTRACT

Being reversible, a protective garment for a military or paramilitary firefighter or emergency worker has a shell of high visibility and a shell of low visibility. The shell of high visibility has portions that are reflective, fluorescent, or both, which the shell of low visibility does not have. When facing outwardly, the shell of low visibility appears black, or at least dark, in ambient light or displays camouflage. Except that the shell of low visibility does not have any reflective or fluorescent portions, the shells conform to National Fire Protection Association (NFPA) standards for outer shells of protective garments for firefighters. The shells are equal, or at least similar, in basis weights.

### CROSS-REFERENCE TO RELATED APPLICATION

This application is a continuation of U.S. patent application Ser. No. 10/350,862, which was filed on Jan. 24, 2003.

### TECHNICAL FIELD OF THE INVENTION

This invention pertains to a protective garment for a firefighter or emergency worker, particularly a military or paramilitary firefighter or emergency worker. This invention contemplates that the protective garment is reversible so as to expose, as an outer shell, either a shell of high visibility or a shell of low visibility.

### BACKGROUND OF THE INVENTION

Protective garments for firefighters and emergency workers include coats, trousers, overalls, and coveralls. Currently, National Fire Protection Association (NFPA) standards require a protective garment for a firefighter to have reflective trim, which enhances the visibility of the protective garment and, therefore, the visibility of its wearer under smoke-laden and other adverse conditions. Generally, reflective trim is affixed by sewing, adhesively, or otherwise.

However, for a military or paramilitary firefighter or emergency worker operating where a tactical operation has developed or is expected to develop, a need for low visibility may override a need for high visibility. Heretofore, a military or paramilitary firefighter or emergency worker may have to be issued two types of protective garments, i.e., protective garments to be worn in a tactical operation, in which the need for low visibility overrides the need for high visibility, and protective garments to be worn otherwise.

### SUMMARY OF THE INVENTION

This invention provides a protective garment for a military or paramilitary firefighter or emergency worker. Being reversible, the protective garment has a shell of high visibility and a shell of low visibility. The protective garment is wearable with either shell facing outwardly. The shell of high visibility has portions that are reflective, fluorescent, or both, which the shell of low visibility does not have. Those portions, which face outwardly when the protective garment is worn so that the shell of high visibility faces outwardly, may be provided by reflective trim affixed by sewing, adhesively, or otherwise to the shell of high visibility. Preferably, when facing outwardly, the shell of low visibility appears black, or at least dark, in ambient light. Alternatively, when facing outwardly, the shell of low visibility displays camouflage.

Preferably, except that the shell of low visibility does not have reflective trim or any reflective or fluorescent portions, the shells conform to National Fire Protection Association (NFPA) standards for outer shells of protective garments for firefighters. Preferably, moreover, the shells are equal, or at least similar, in basis weights.

### BRIEF DESCRIPTION OF THE DRAWINGS

FIG. 1 is a front elevation of a protective coat embodying this invention, as worn with its shell of high visibility facing outwardly.

FIG. 2 is a front elevation of the same coat, as worn with its shell of low visibility facing outwardly.

FIGS. 3 and 4 are cross-sections, as taken respectively along line 3-3 of FIG. 1 and along line 4-4 of FIG. 2, in directions indicated by arrows.

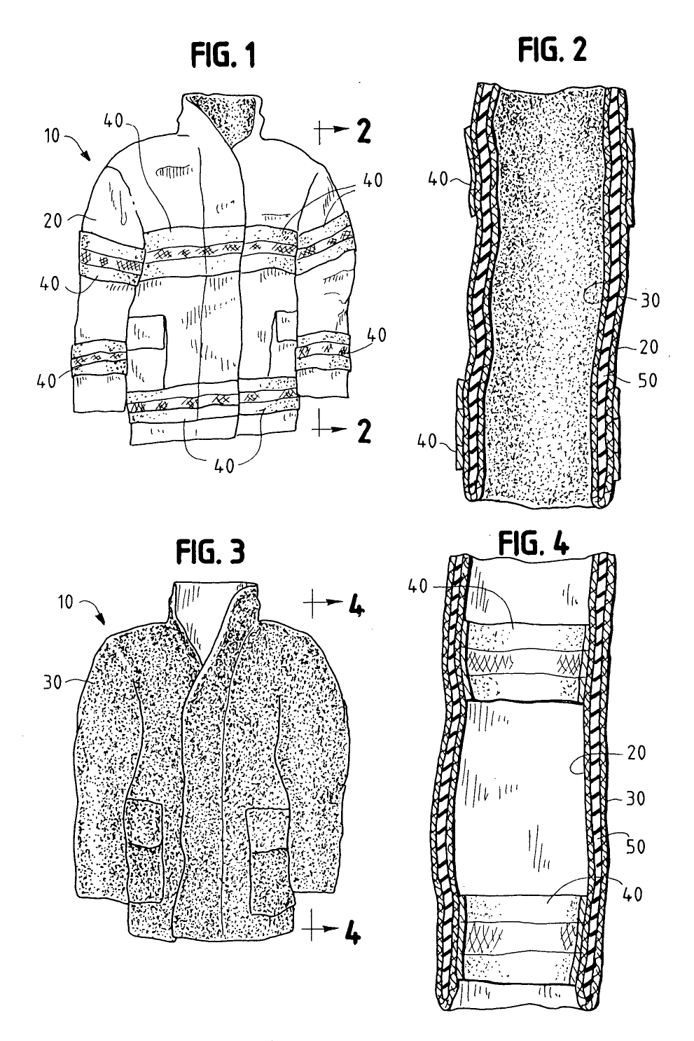

### DETAILED DESCRIPTION OF THE ILLUSTRATED EMBODIMENT

As illustrated, a protective coat 10 for a military or paramilitary firefighter or emergency worker embodies this invention and has a shell 20 of high visibility and a shell 30 of low visibility. As contemplated by this invention, the shell 20 of high visibility has several strips 40 of reflective trim, which the shell 30 of low visibility does not have. Preferably, when facing outwardly, the shell 30 of low visibility appears black, or at least dark, in ambient light. Alternatively, when facing outwardly, the shell 30 of low visibility displays camouflage.

Preferably, except that the shell 30 of low visibility does not have reflective trim, the shells conform in weight, tear strength, and other characteristics to National Fire Protection Association (NFPA) standards for outer shells of protective garments for firefighters. Preferably, moreover, the shells 20, 30, are equal, or at least similar, in basis weights. A preferred material for the shells 20, 30, is Nomex™ material having a basis weight of nine ounces (9 oz.) per square yard, as available commercially from E. I. du Pont de Nemours and Company of Wilmington, Del. Such material is available commercially in patterns that display camouflage. Scotchlite™ reflective trim is suitable, as available commercially from Minnesota Mining and Manufacturing Company of St. Paul, Minn.

As illustrated, the protective coat 10 has between the shells 20, 30, a layer 50 providing a moisture barrier. Along with the layer 50 providing the moisture barrier, another layer or other layers may be also provided between the shells 20, 30, such as a layer providing thermal insulation. Although a protective coat is illustrated, this invention may be also embodied in other protective garments, such as trousers, overalls, and coveralls.

In a tactical operation, in which the need for low visibility overrides the need for high visibility, a military or paramilitary firefighter or emergency worker may wear the protective coat 10 with the shell 30 of low visibility facing outwardly. Otherwise, the firefighter or emergency worker may wear the protective coat 10 with the shell 20 of high visibility facing outwardly. If a tactical operation develops or is expected to develop while a military or paramilitary firefighter or emergency worker is wearing the protective garment 10 with the shell 20 of high visibility facing outwardly, the firefighter or emergency worker may have an opportunity to doff the protective coat 10, reverse it, and re-don it with the shell 30 of low visibility facing outwardly.

1. A method for protecting a military or paramilitary firefighter or emergency worker, wherein the method comprises providing the military or paramilitary firefighter or emergency worker with a protective garment, which is a coat, trousers, overalls, or coveralls, which is reversible, which has a shell of high visibility and a shell of low visibility, and which is wearable with either shell facing outwardly while other shell faces inwardly, and wherein the shell of high visibility has portions that are reflective, fluorescent, or both, which portions face outwardly when the protective garment is worn so that the shell of high visibility faces outwardly,
wherein, if a tactical situation, in which a need for low visibility overrides a need for high visibility, develops or is expected to develop, the military or paramilitary firefighter or emergency worker wearing the protective garment with the shell of high visibility facing outwardly and with the shell of low visibility facing inwardly is motivated to doff the protective garment, to reverse the protective garment, and to re-don the protective garment with the shell of low visibility facing outwardly and with the shell of high visibility facing inwardly.

2. The method of claim 1 wherein those portions are provided by reflective trim affixed to the shell of high visibility.

3. A method for protecting a military or paramilitary firefighter or emergency worker, wherein the method comprises providing the military or paramilitary firefighter or emergency worker with a protective garment, which is a coat, trousers, overalls, or coveralls, which is reversible, which has a shell of high visibility and a shell of low visibility, and which is wearable with either shell facing outwardly while the other shell faces inwardly, wherein the shell of high visibility has portions that are reflective, fluorescent, or both, which portions face outwardly when the protective garment is worn so that the shell of high visibility faces outwardly, wherein, when facing outwardly, the shell of low visibility appears dark in ambient light,
wherein, if a tactical situation, in which a need for low visibility overrides a need for high visibility, develops or is expected to develop, the military or paramilitary firefighter or emergency worker wearing the protective garment with the shell of high visibility facing outwardly and with the shell of low visibility facing inwardly is motivated to doff the protective garment, to reverse the protective garment, and to re-don the protective garment with the shell of low visibility facing outwardly and with the shell of high visibility facing inwardly.

4. A method for protecting a military or paramilitary firefighter or emergency worker, wherein the method comprises providing the military or paramilitary firefighter or emergency worker with a protective garment, which is a coat, trousers, overalls, or coveralls, which is reversible, which has a shell of high visibility and a shell of low visibility, and which is wearable with either shell facing outwardly while the other shell faces inwardly, wherein the shell of high visibility has portions that are reflective, fluorescent, or both, which portions face outwardly when the protective garment is worn so that the shell of high visibility faces outwardly, wherein, when facing outwardly, the shell of low visibility appears black in ambient light,
wherein, if a tactical situation, in which a need for low visibility overrides a need for high visibility, develops or is expected to develop, the military or paramilitary firefighter or emergency worker wearing the protective garment with the shell of high visibility facing outwardly and with the shell of low visibility facing inwardly is motivated to doff the protective garment, to reverse the protective garment, and to re-don the protective garment with the shell of low visibility facing outwardly and with the shell of high visibility facing inwardly.

5. A method for protecting a military or paramilitary firefighter or emergency worker, wherein the method comprises providing the military or paramilitary firefighter or emergency worker with a protective garment, which is a coat, trousers, overalls, or coveralls, which is reversible, which has a shell of high visibility and a shell of low visibility, and which is wearable with either shell facing outwardly while the other shell faces inwardly, wherein the shell of high visibility has portions that are reflective, fluorescent, or both, which portions face outwardly when the protective garment is worn so that the shell of high visibility faces outwardly, wherein, when facing outwardly, the shell of low visibility displays camouflage,
wherein, if a tactical situation, in which a need for low visibility overrides a need for high visibility, develops or is expected to develop, the military or paramilitary firefighter or emergency worker wearing the protective garment with the shell of high visibility facing outwardly and with the shell of low visibility facing inwardly is motivated to doff the protective garment, to reverse the protective garment, and to re-don the protective garment with the shell of low visibility facing outwardly and with the shell of high visibility facing inwardly.

6. (canceled)

7. The method of claim 5 wherein the shells are similar in basis weights.

8. The method of claim 5 wherein the shells are equal in basis weights.

9. A method for protecting a military or paramilitary firefighter or emergency worker, wherein the method is practiced by the military or paramilitary firefighter or emergency worker and comprises wearing a protective garment, which is a coat trousers, overalls, or coveralls, which is reversible, which has a shell of high visibility and a shell of low visibility, and which is wearable with either shell facing outwardly while the other shell faces inwardly, and wherein the shell of high visibility has portions that are reflective, fluorescent, or both, which portions face outwardly when the protective garment is worn so that the shell of high visibility faces outwardly,
wherein, if a tactical situation, in which a need for low visibility overrides a need for high visibility, develops or is expected to develop, the military or paramilitary firefighter or emergency worker wearing the protective garment with the shell of high visibility facing outwardly and with the shell of low visibility facing inwardly is motivated to doff the protective garment, to reverse the protective garment, and to re-don the protective garment with the shell of low visibility facing outwardly and with the shell of high visibility facing inwardly.

10. The method of claim 9 wherein those portions are provided by reflective trim affixed to the shell of high visibility.

11. A method for protecting a military or paramilitary firefighter or emergency worker, wherein the method is practiced by the military or paramilitary firefighter or emergency worker and comprises wearing a protective garment, which is a coat, trousers, overalls, or coveralls, which is reversible, which has a shell of high visibility and a shell of low visibility, and which is wearable with either shell facing outwardly while the other shell faces inwardly, wherein the shell of high visibility has portions that are reflective, fluorescent, or both, which portions face outwardly when the protective garment is worn so that the shell of high visibility faces outwardly, wherein, when facing outwardly, the shell of low visibility appears dark in ambient light,
wherein, if a tactical situation, in which a need for low visibility overrides a need for high visibility, develops or is expected to develop, the military or paramilitary firefighter or emergency worker wearing the protective garment with the shell of high visibility facing outwardly and with the shell of low visibility facing inwardly is motivated to doff the protective garment, to reverse the protective garment, and to re-don the protective garment with the shell of low visibility facing outwardly and with the shell of high visibility facing inwardly.

12. A method for protecting a military or paramilitary firefighter or emergency worker, wherein the method is practiced by the military or paramilitary firefighter or emergency worker and comprises wearing a protective garment, which is a coat, trousers, overalls, or coveralls, which is reversible, which has a shell of high visibility and a shell of low visibility, and which is wearable with either shell facing outwardly while the other shell faces inwardly, wherein the shell of high visibility has portions that are reflective, fluorescent, or both, which portions face outwardly when the protective garment is worn so that the shell of high visibility faces outwardly, wherein, when facing outwardly, the shell of low visibility appears black in ambient light,
wherein, if a tactical situation, in which a need for low visibility overrides a need for high visibility, develops or is expected to develop, the military or paramilitary firefighter or emergency worker wearing the protective garment with the shell of high visibility facing outwardly and with the shell of low visibility facing inwardly is motivated to doff the protective garment, to reverse the protective garment, and to re-don the protective garment with the shell of low visibility facing outwardly and with the shell of high visibility facing inwardly.

13. A method for protecting a military or paramilitary firefighter or emergency worker, wherein the method is practiced by the military or paramilitary firefighter or emergency worker and comprises wearing a protective garment, which is a coat, trousers, overalls, or coveralls, which is reversible, which has a shell of high visibility and a shell of low visibility, and which is wearable with either shell facing outwardly while the other shell faces inwardly, wherein the shell of high visibility has portions that are reflective, fluorescent, or both, which portions face outwardly when the protective garment is worn so that the shell of high visibility faces outwardly, wherein, when facing outwardly, the shell of low visibility displays camouflage,
wherein, if a tactical situation, in which a need for low visibility overrides a need for high visibility, develops or is expected to develop, the military or paramilitary firefighter or emergency worker wearing the protective garment with the shell of high visibility facing outwardly and with the shell of low visibility facing inwardly is motivated to doff the protective garment, to reverse the protective garment, and to re-don the protective garment with the shell of low visibility facing outwardly and with the shell of high visibility facing inwardly.

14. (canceled)

15. The method of claim 13 wherein the shells are similar in basis weights.

16. The method of claim 13 wherein the shells are equal in basis weights.
